(19) United States
(12) Patent Application Publication
(10) Pub. No.: US 2015/0212993 A1
(43) Pub. Date: Jul. 30, 2015

(54) Impact Coverage

(71) Applicant: International Business Machines Corporation, Armonk, NY (US)

(72) Inventors: Eitan D. Farchi, Pardes Hana (IL); Mircea Namolaru, Haifa (IL); Orna Raz-Pelleg, Haifa (IL)

(73) Assignee: International Business Machines Corporation, Armonk, NY (US)

(21) Appl. No.: 14/168,017

(22) Filed: Jan. 30, 2014

(51) Int. Cl. G06F 17/24; G06F 17/27

(52) U.S. Cl. CPC G06F 17/24; G06F 17/27

(57) ABSTRACT

A method that includes obtaining an area of text that has changed in a functional document, wherein the functional document corresponds to one or more coverage tasks. The method also includes computing an impact measurement for each of the one or more coverage task, wherein the impact measurement is indicative of a potential to be impacted by the change. As a result of the method it is possible to identify coverage tasks that are estimated to be impacted by the change of the functional document.

### TECHNICAL FIELD

The present disclosure relates to quality assurance in general, and to coverage analysis, in particular.

### BACKGROUND

Code coverage aims to measure how much code a test suite executes. There exist many code coverage metrics. However, the existing metrics give the same weight to the different code locations that are defined by the metric.

Code review and review of other technical documents are known techniques used for quality assurance. After a revision of a document is completed, the revision may be manually reviewed by quality assurance personnel which may manually attempt to locate potential bugs that were introduced by the revision.

### BRIEF SUMMARY

One exemplary embodiment of the disclosed subject matter is a computer-implemented method comprising: obtaining an area of text that has changed in a functional document, wherein the functional document corresponds to one or more coverage tasks; computing, by a processor, an impact measurement for each of the one or more coverage task, wherein the impact measurement is indicative of a potential to be impacted by the change; and whereby identifying coverage tasks that are estimated to be impacted by the change of the functional document.

Another exemplary embodiment of the disclosed subject matter is a computerized apparatus having a processor, the processor being adapted to perform the steps of: obtaining an area of text that has changed in a functional document, wherein the functional document corresponds to one or more coverage tasks; computing an impact measurement for each of the one or more coverage task, wherein the impact measurement is indicative of a potential to be impacted by the change; and whereby identifying coverage tasks that are estimated to be impacted by the change of the functional document.

Yet another exemplary embodiment of the disclosed subject matter is a computer program product comprising a non-transitory computer readable medium retaining program instructions, which instructions when read by a processor, cause the processor to perform a method comprising: obtaining an area of text that has changed in a functional document, wherein the functional document corresponds to one or more coverage tasks; computing an impact measurement for each of the one or more coverage task, wherein the impact measurement is indicative of a potential to be impacted by the change; and whereby identifying coverage tasks that are estimated to be impacted by the change of the functional document.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a flowchart diagram of a method, in accordance with some exemplary embodiments of the disclosed subject matter;

FIG. 2 shows an illustration of a display, in accordance with some exemplary embodiments of the disclosed subject matter; and

FIG. 3 shows a block diagram of an apparatus, in accordance with some exemplary embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem dealt with by the disclosed subject matter is to provide a coverage metric that takes into account the probability that specific portions of the code are impacted by a change.

It will be understood that the disclosed subject matter relates to any form of functional document, including, for example, design documents, technical specification and the like. The disclosed subject matter is not limited to program code. However, for the purpose of a clear disclosure, the disclosure focuses on an embodiment in which the document is program code.

One technical solution provided by the disclosed subject matter is to provide a coverage metric that is based on estimated impact in view of a change. The impact may be estimated based on past revisions (e.g., history of a version control system). The impact may be estimated based on text mining techniques. In some cases. The text mining techniques may be language-agnostic and may be indifferent of the specific programming language that was used to write the code and may be used for non-formal languages, such as pseudo-code, English and other languages used to write design documents.

In some exemplary embodiments, the disclosed subject matter may be used to define weights to coverage tasks, such as code coverage tasks (e.g., corresponding to code lines to cover during testing, or other code elements), which are based on the probability that the pertinent code was impacted by the modification. The weights may be used to prioritize testing so as to cover code coverage with higher weights at an earlier time. Additionally or alternatively, the weights may be used to visually indicate portions of the code so as to direct a reviewer's attention towards the portions which are potentially impacted by a modification.

The disclosed subject matter may be used to effectively strengthen an existing test suite. The disclosed subject matter may be used to select tests to run in a regression when time is limited, such as for example selecting first tests that have a high probability to detect bugs. The disclosed subject matter may be used to select code segments to review when resources are limited. It will be noted that in many cases it is only feasible to review a small amount of the code. As this may be the case, there may be a need to use the time available for reviews in the most effective way possible.

In some exemplary embodiments, the weights may be used in combination with other forms of weights, such as by performing a weighted average of different weights, either as computed by the disclosed subject matter or by other techniques.

In some exemplary embodiments, text mining may be performed such as using text similarity computations, statistical correlation, and clustering. Such text mining techniques may be utilized to identify additional elements that may be impacted by a change.

In some exemplary embodiments, the disclosed subject matter may not utilize static analysis of the program code which may be programming language dependent.

One technical effect of utilizing the disclosed subject matter is to identify impact such as invoking the changed code, copy-paste of the changed code, code hierarchy such as inheritance similar to the changed code, and the like. Such an effect may be obtained without prior knowledge of the programming language being used, its syntax and other characteristics and may even be useful in case that pseudo code that does not adhere to any formal language definition is being used.

Another technical effect may be identifying “hot-spots” in the code based on past modifications of the code itself. Such “hot-spots” may be deemed as important to review as they have a history of being modified and if not presently modified it may be wise to investigate as to whether or not they are impacted by the current revision.

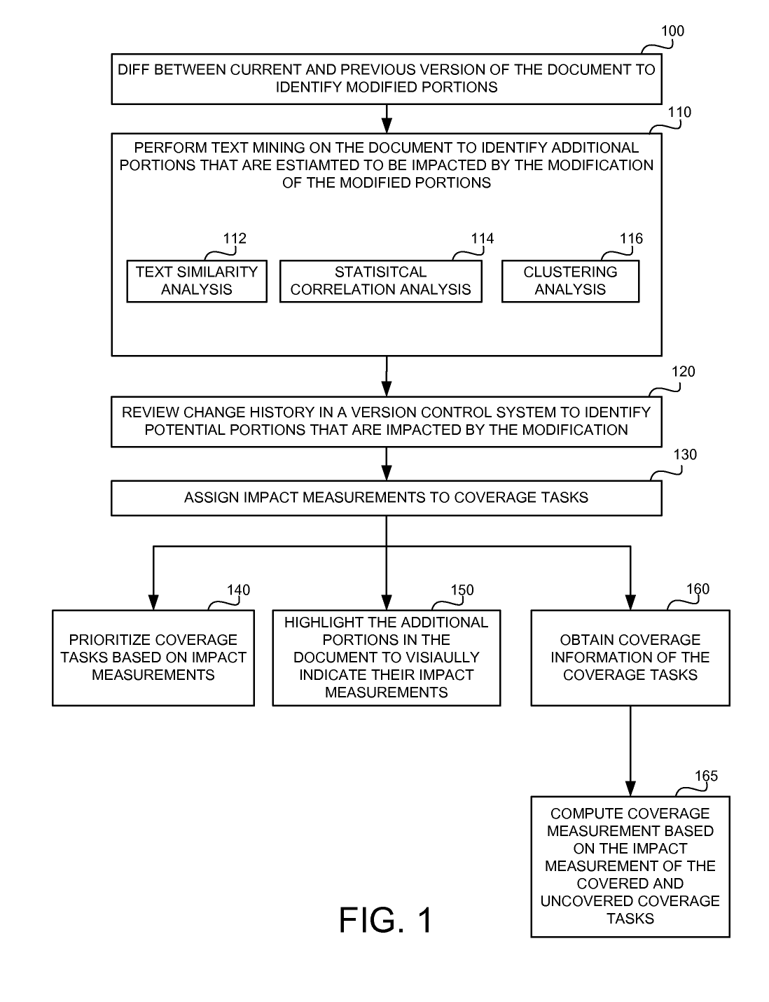

Reference is now made to FIG. 1 showing a flowchart diagram of a method, in accordance with some exemplary embodiments of the disclosed subject matter.

In Step 100, a change in the document may be obtained. The change may be obtained by performing a comparison between a current and previous versions of the code to identify the modified portions. In some exemplary embodiments, the comparison may be performed using a diff tool.

In Step 110, text mining may be performed on the document to identify additional portions that may be estimated to be impacted by the change. The text mining may be language agnostic, such as based on text similarity analysis (112), statistical correlation analysis (114), clustering analysis (116), or the like. It will be noted that the disclosed subject matter may be a heuristic. False positive indications (e.g., locations that are erroneously indicated as impacted), false negative indications (e.g., locations that are erroneously indicated as not impacted) or the like may occur. When testing and utilizing the disclosed subject matter to prioritize the heuristic may be sufficient to provide a desired benefit without requiring high overhead that is associated with exact analysis or with analysis that requires avoiding false negative indications and/or false positive indications.

In Step 120, change history of the program code may be reviewed. The review may be useful to identify potential code elements that are impacted by the modification (e.g., in the past, when a first element was modified, a second element was also, sometimes, modified. This may hint that if the first element is now modified, the second element is impacted). Additionally or alternatively, the history may be used to identify hot-spots: code elements that are frequently modified and therefore may be assumed to be impacted by most modifications of the code.

In some exemplary embodiments, Step 120 is performed by checking a version control system or a similar tool.

In Step 130, impact measurements may be computed based on the determinations of Step 110, Step 120, or the combination thereof. Each coverage task may be assigned with an impact measurement based on the estimated likelihood that the corresponding code element is impacted by the modification. In some exemplary embodiments, the impact measurement may be a number between zero and one. As an example only, the impact measurement may be an estimated probability that the modification impacted the coverage task.

In Step 140, the coverage tasks may be prioritized based on the impact measurements. The prioritization may be used to perform partial testing when, for example, there is not enough time to run an entire test suite. The partial testing may include those tests that cover the coverage tasks with the highest priorities.

In Step 150, the code may be displayed and additional portions of the code, in addition or instead of the modified portions, may be highlighted or visually marked in another manner. The additional portions may correspond to the coverage tasks (e.g., code elements corresponding to the coverage tasks) having an impact measurement above a predetermined threshold. As an example, the threshold may be 0.2 (20%) and every code element that is associated with a coverage task that has an impact measurement above 0.2 may be highlighted. Additionally or alternatively, the threshold may be about 0.50, about 0.7, or the like. In some exemplary embodiments, the highlighting may be performed using color or other visual indications that allow to distinguish between different impact measurements. As an example, a code that is associated with a higher impact measurement may be highlighted in a darker red hue than another code.

In Step 160, coverage information of the coverage tasks may be obtained. The coverage information may include indications which coverage tasks are covered and which are uncovered. The coverage information may be obtained in response to executing a test suite, or testing the code in another manner.

In Step 165, coverage measurement may be computed. The coverage measurement may be computed while taking into account the impact measurement of the covered coverage tasks. Additionally or alternatively, the coverage measurement may be computed while taking into account the impact measurement of the uncovered coverage tasks. As an example only, the coverage measurement may be computed using the following formula:

$$\frac{{\sum }_{{T}_{i} ∈ COVERED}^{ } impact ( {T}_{i} )}{{\sum }_{{T}_{j}}^{ } impact ( {T}_{j} )} .$$

In other words, the coverage measurement may be the sum of the impact measurements of the covered coverage tasks divided by the sum of the impact measurements of all covered coverage tasks. As can be appreciated such a measurement is not only affected by the number of covered coverage tasks but gives a different weight to different coverage tasks so as covering one coverage task may result in a greater increase of the coverage measurement than if another coverage task is covered.

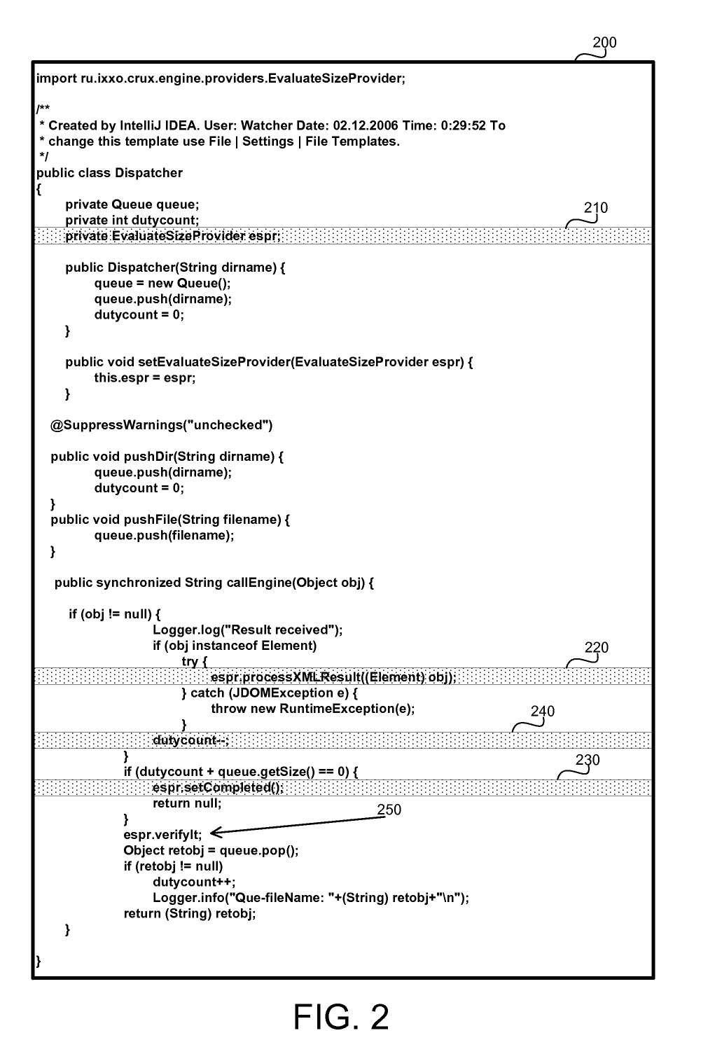

Referring now to FIG. 2 showing an illustration of a display, in accordance with some exemplary embodiments of the disclosed subject matter. Display 200 displays a program code. Based on a modification of the code, such as a modification affecting the EvaluateSizeProvider class (modification not shown), impact analysis may deduce that certain code elements are potentially impacted. Code Line 210, in which an object of the class is defined, may be indicated as potentially impacted, such as by highlighting the line.

As another example, the modification may relate to a specific function, such as that which is invoked in Code Line 220. Text mining may identify the potential impact without having knowledge of the syntax or semantics of the programming language being used.

As another example, if the function setCompleted is modified in a father class of the EvaluateSizeProvider class, the invocations of the function may be modified throughout the program code. As such, text mining may be useful to identify that Code Line 230 is also potentially impacted. Such a determination may be performed even though the text mining was not made explicitly aware of the inheritance relationship.

In some exemplary embodiments, the text mining may result in false positive indications such as Code Line 240, which may have been erroneously marked. Additionally or alternatively, the text mining may result in false negative indications such as potentially Code Line 250, which may have been erroneously not marked.

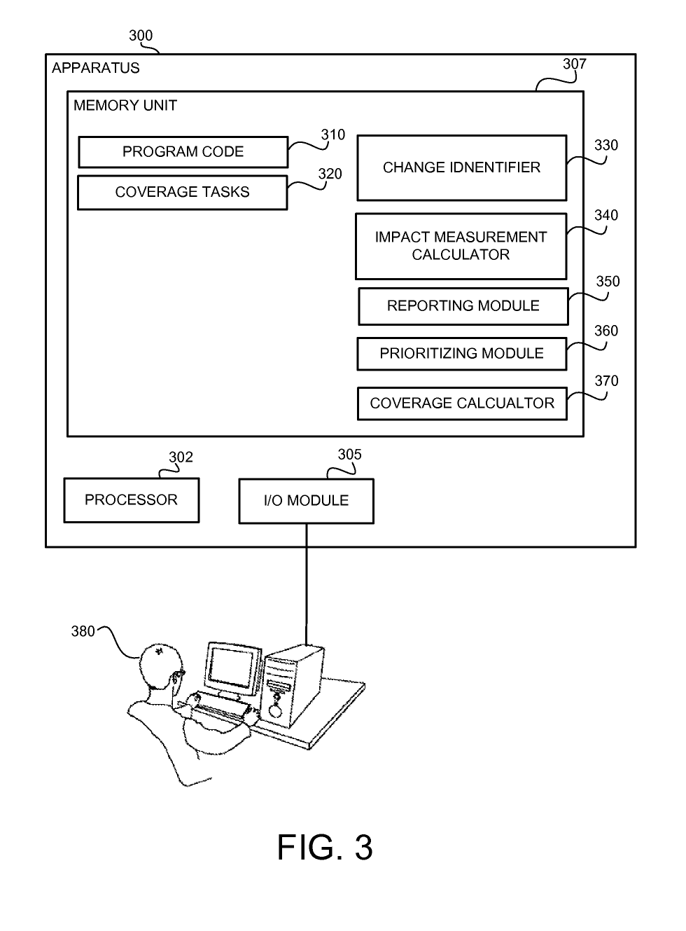

Referring now to FIG. 3 showing a block diagram of components of an apparatus, in accordance with some exemplary embodiments of the disclosed subject matter. An apparatus 300 may be a computerized apparatus adapted to perform methods such as depicted in FIG. 1.

In some exemplary embodiments, Apparatus 300 may comprise a Processor 302. Processor 302 may be a Central Processing Unit (CPU), a microprocessor, an electronic circuit, an Integrated Circuit (IC) or the like. Alternatively, Apparatus 300 can be implemented as firmware written for or ported to a specific processor such as Digital Signal Processor (DSP) or microcontrollers, or can be implemented as hardware or configurable hardware such as field programmable gate array (FPGA) or application specific integrated circuit (ASIC). Processor 302 may be utilized to perform computations required by Apparatus 300 or any of it subcomponents.

In some exemplary embodiments of the disclosed subject matter, Apparatus 300 may comprise an Input/Output (I/O) Module 305 such as a terminal, a display, a keyboard, an input device or the like to interact with the system, to invoke the system and to receive results. It will however be appreciated that the system can operate without human operation.

In some exemplary embodiments, the I/O Module 205 may be utilized to provide an interface to a User 380 to interact with Apparatus 300, such as to present the display to User 380, to indicate computed coverage measurement, to output prioritized list of coverage tasks, or the like.

In some exemplary embodiments, Apparatus 300 may comprise a Memory Unit 307. Memory Unit 307 may be persistent or volatile. For example, Memory Unit 307 can be a Flash disk, a Random Access Memory (RAM), a memory chip, an optical storage device such as a CD, a DVD, or a laser disk; a magnetic storage device such as a tape, a hard disk, storage area network (SAN), a network attached storage (NAS), or others; a semiconductor storage device such as Flash device, memory stick, or the like. In some exemplary embodiments, Memory Unit 307 may retain program code operative to cause Processor 302 to perform acts associated with any of the steps shown in FIG. 1.

Program Code 310 may be retained on Memory Unit 307. In some exemplary embodiments, current and previous versions of Program Code 310 may be retained.

In some exemplary embodiments, Coverage Tasks 320 may indicate a set of coverage tasks of relating to Program Code 310. Coverage Tasks 320 may be code coverage tasks, such as each associated with a different code element of Program Code 310.

The components detailed below may be implemented as one or more sets of interrelated computer instructions, executed for example by Processor 302 or by another processor. The components may be arranged as one or more executable files, dynamic libraries, static libraries, methods, functions, services, or the like, programmed in any programming language and under any computing environment.

Change Identifier 330 may be configured to identify a change in Program Code 310. The change may be identified by comparing a current version of Program Code 310 with a previous version of Program Code 310.

Impact Measurement Calculator 340 may be configured to compute an impact measurement to each coverage task of Coverage Tasks 320. Impact Measurement Calculator 340 may utilize text mining in order to compute the impact measurement. Additionally or alternatively, Impact Measurement Calculator 340 may utilize a version control system in order to identify trends and estimate impact. In some exemplary embodiments, Impact Measurement Calculator 340 may be language-agnostic and may be indifferent on whether Program Code 310 is written in Java, in C, or even using a non-formal language or with syntax errors.

Reporting Module 350 may be configured to report to User 380 the impact measurements, In some exemplary embodiments, impact measurements may be reported by a printout report by listing values for each coverage task. In some exemplary embodiments, the report may be provided by display a display such as Display 200 which utilizes coloring to indicate the impact measurement of coverage tasks. Different coloring schemes may be used to indicate a value of the impact measurement, such as ranging from red to blue.

Prioritizing Module 360 may utilize the impact measurements to prioritize Coverage Tasks 320 during testing. In some exemplary embodiments, Prioritizing Module 360 may be useful for selecting a subset of a test suite to be used when there are not sufficient resources to execute the entire test suite.

Coverage Calculator 370 may be configured to compute a coverage metric based on a list of covered coverage tasks taking into account their impact measurement and/or the impact measurements of the uncovered coverage tasks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method comprising:
obtaining an area of text that has changed in a functional document, wherein the functional document corresponds to one or more coverage tasks;
computing, by a processor, an impact measurement for each of the one or more coverage task, wherein the impact measurement is indicative of a potential to be impacted by the change; and
whereby identifying coverage tasks that are estimated to be impacted by the change of the functional document.

2. The computer-implemented method of claim 1, wherein the impact measurement is computed by performing text mining on the functional document to identify one or more portions of the functional documents that are similar to the area of text that has changed, wherein the one or more portions of the functional documents are different than the area of text that has changed;

3. The computer-implemented method of claim 2, wherein said text mining is language-agnostic.

4. The computer-implemented method of claim 2, wherein said text mining is a heuristic analysis which potentially provides false positive indications and false negative indications.

5. The computer-implemented method of claim 2, wherein said text mining is selected from the group consisting of: text similarity analysis, statistical correlation and clustering.

6. The computer-implemented method of claim 1, wherein said impact measurement is computed based on history of changes as reflected by a version control system which is used to track versions of the functional document.

7. The computer-implemented method of claim 1, wherein the functional document is selected from the group consisting of a program code and a design document.

8. The computer-implemented method of claim 1, wherein said obtaining areas of texts that have changed in a functional document comprises performing a textual comparison between a first version of the functional document and a second version of the functional document.

9. The computer-implemented method of claim 1 further comprises prioritizing order of desired coverage of the one or more coverage tasks based on the impact measurement.

10. The computer-implemented method of claim 1 further comprises computing coverage measurement of the functional document, wherein the coverage measurement is based on the impact measurements of covered and uncovered coverage tasks of the one or more coverage tasks.

11. The computer-implemented method of claim 1 further comprises:
displaying to a user the functional document, wherein said displaying comprises marking the functional document to visually indicate coverage tasks having an impact measurement above a predetermined threshold.

12. A computerized apparatus having a processor, the processor being adapted to perform the steps of:
obtaining an area of text that has changed in a functional document, wherein the functional document corresponds to one or more coverage tasks;
computing an impact measurement for each of the one or more coverage task, wherein the impact measurement is indicative of a potential to be impacted by the change; and
whereby identifying coverage tasks that are estimated to be impacted by the change of the functional document.

13. The computerized apparatus of claim 12, wherein the impact measurement is computed by performing text mining on the functional document to identify one or more portions of the functional documents that are similar to the area of text that has changed, wherein the one or more portions of the functional documents are different than the area of text that has changed;

14. The computerized apparatus of claim 13, wherein said text mining is language-agnostic.

15. The computerized apparatus of claim 13, wherein said text mining is a heuristic analysis which potentially provides false positive indications and false negative indications.

16. The computerized apparatus of claim 12, wherein said impact measurement is computed based on history of changes as reflected by a version control system which is used to track versions of the functional document.

17. The computerized apparatus of claim 12, wherein the processor is further adapted to: prioritize order of desired coverage of the one or more coverage tasks based on the impact measurement.

18. The computerized apparatus of claim 12, wherein the processor is further adapted to: compute coverage measurement of the functional document, wherein the coverage measurement is based on the impact measurements of covered and uncovered coverage tasks of the one or more coverage tasks.

19. A computer program product comprising a non-transitory computer readable medium retaining program instructions, which instructions when read by a processor, cause the processor to perform a method comprising:
obtaining an area of text that has changed in a functional document, wherein the functional document corresponds to one or more coverage tasks;
computing an impact measurement for each of the one or more coverage task, wherein the impact measurement is indicative of a potential to be impacted by the change; and
whereby identifying coverage tasks that are estimated to be impacted by the change of the functional document.
